(19) United States
(12) Patent Application Publication
(10) Pub. No.: US 2009/0185877 A1
(43) Pub. Date: Jul. 23, 2009

(54) Gundrill, and method of drilling with the same

(76) Inventor: Mort McClennan, Chargin Falls, OH (US)

Correspondence Address: Ilya Zborovsky, 6 Schoolhouse Way, Dix Hills, NY, 11746, US

(21) Appl. No.: 12/009,428

(22) Filed: Jan. 22, 2008

(51) Int. Cl. B23B 51/02

(52) U.S. Cl. 408/1 R; 408/230; 408/226

(57) ABSTRACT

A single flute gundrill has a cutting tip having a single cutting edge arranged so that when the gundrill rotates the cutting edge performs cutting in a predetermined cutting direction; a shank having a front end to which the cutting tip is connected and a rear end; and a driver connected to the rear end of said shank, the shank being provided with a single convoluted groove with a direction of convolution coinciding with the cutting direction of the gundrill.

### BACKGROUND OF THE INVENTION

The present invention relates to a single flute gundrill, herinafter referred to simply as “gundrill” and a method of drilling with the same.

Gundrills are well known in the art. A gundrill, by its original definition, was designed to drill long, straight, close tolerance holes with superior surface finish in gun barrels. By design, a gundrill is a self-piloting, high pressure coolant fed drill with external chip removal that performs two machining processes simultaneously, namely drilling (by its cutting edge) and burnishing (deforming the side walls of the hole being drilled by the supporting pads). The unbalanced axial and radial cutting forces generated by the inner and outer angles of the single cutting edge in the drilling process are countered by equal and opposite forces as the supporting pad(s) bear against the side wall of the hole being drilled. In addition to this, a characteristic inverted conical shape is created at the bottom of the hole. The inside cutting edge, sweeping around this cone as it penetrates the part, further serves to stabilize the gundrill and keep it on its axis.

A gundrill is typically although not always a three-piece construction. It includes a carbide tip which is brazed onto a V-fluted steel shank, which is then brazed to a steel driver. Functional diameters usually range from 0.030″ to 3.0″ with lengths from 3″ to 30 feet.

Drilling with gundrills is generally a high speed, low feed operation, widely used in manufacturing to drill a variety of both ferrous and non-ferrous materials. It is often the drill of choice when straightness, size and/or surface finish are critical, and the depth of the hole to be drilled exceeds 6 times its diameter.

Primary factors limiting the gundrill feed rate are its torsion strength and its ability to break the chips. Primary factors limiting the speed of the gundrill are the thermal characteristics of both the workpiece and the carbide tip, the coolant system, and an inherent limitation of the tube (shank) known as the “maximum allowable unsupported drill length.”

Due to the provision of the single, straight V-flute in known gundrills, the center of gravity of the gundrill is not on the axis of rotation or centerline of the drill. As a result, centrifugal forces are exerted along the entire length of the tubular shank of the gundrill, acting in a direction opposite the V-flute, resulting in a phenomenon called “whipping”. In order to counter this whipping phenomena, the existing gundrills are provided with whip guides at the entrance to the chip box and along the length of the drill, in an effort to minimize the degree of whipping.

Some gundrills are disclosed in U.S. Pat. Nos. 3,010,345; 3,089,359; 3,153,356; 4,284,375; 4,395,169 and also in European patent application EP 1 428 601.

It is believed the existing gundrills can be further improved.

### SUMMARY OF THE INVENTION

Accordingly, it is an object of the present invention to provide a gundrill, and a method of drilling with the same, which is a further improvement of the existing gundrills and methods of their use.

In keeping with these objects and with others which will become apparen thereinafter, one feature of the present invention resides, briefly stated, in a single flute gundrill, comprising a cutting tip having a single cutting edge arranged so that when the gundrill rotates said cutting edge performs cutting in a predetermined cutting direction; a shank having a front end to which said cutting tip is connected and a rear end; and a driver connected to said rear end of said shank, said shank being provided with a single convoluted groove with a direction of convolution coinciding with the cutting direction of the gundrill.

Still a further feature of the present invention resides, briefly stated, in a method of drilling including the steps of providing a single flute gundrill, comprising a cutting tip having a single cutting edge arranged so that when the gundrill rotates said cutting edge performs cutting in a predetermined cutting direction; a shank having a front end to which said cutting tip is connected and a rear end; and a driver connected to said rear end of said shank, said shank being provided with a single convoluted groove with a direction of convolution coinciding with the cutting direction of the gundrill.

When the gundrill is designed in accordance with the present invention and the drilling is performed in accordance with the present invention, the drilling is performed more efficiently than with existing gundrills.

In the inventive gundrill offsetting centrifugal forces are created on the shank, which counter one another, allowing the gundrill to rotate at higher speeds, while eliminating or minimizing the whipping phenomena. Higher production rates are achieved with the inventive gundrill.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a gundrill in accordance with the present invention;

FIG. 2 is a view showing a cutting tip of the gundrill in accordance with the present invention;

FIG. 3 is a view showing a cross-section of a shank of the inventive gundrill;

FIG. 4 is a view showing rotational forces on a prior art gundrill;

FIG. 5 is a view showing rotational forces on the gundrill in accordance with the present invention.

FIG. 6 is a view showing the cross section of a gundrill tip.

### DESCRIPTION OF THE PREFERRED EMBODIMENTS

A gundrill in accordance with the present invention has a cutting tip which can be formed, for example as a carbide tip and identified with reference numeral 1.

The gundrill further has a V-fluted shank which can be formed, for example, as a steel shank and has a single flute. The shank is identified with reference numeral 2. The shank can be formed as a hollow tubular element or as a solid rod-shaped element.

The gundrill further has a driver formed, for example as a steel driver, as identified with reference numeral 3.

The carbide tip 1 is connected with the steel shank, for example, by brazing. The steel shank is connected with the steel driver also, for example, by brazing the shank into the steel driver.

The functional diameters of the gundrill in accordance with the present invention can range range from 0.030″ to 3.0″ with lengths from 3″ to 30′. The diameter of the shank 2 is at least 0.005″ less then the diameter of the carbide tip 1

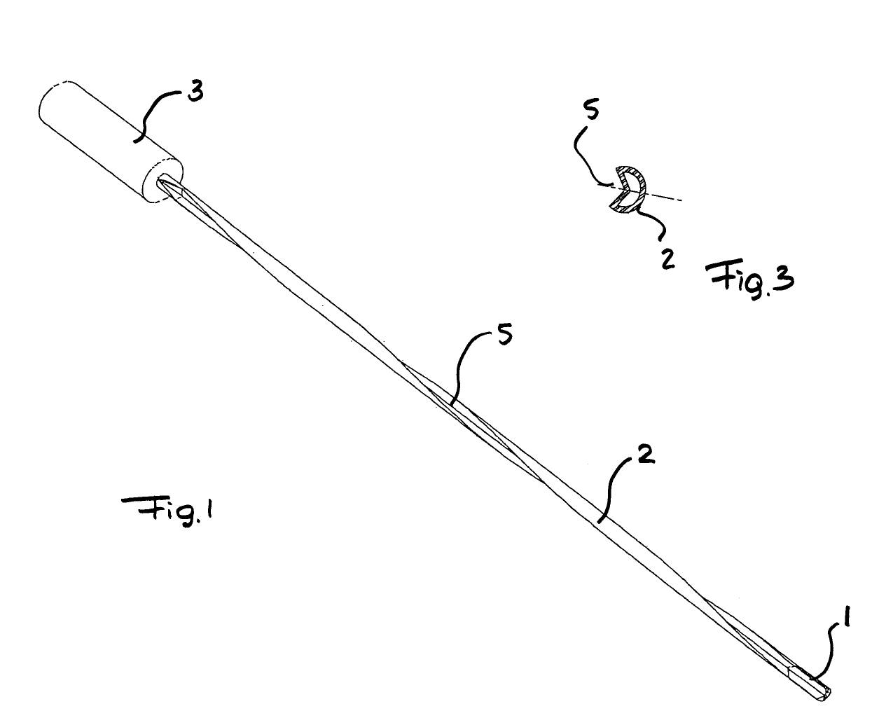

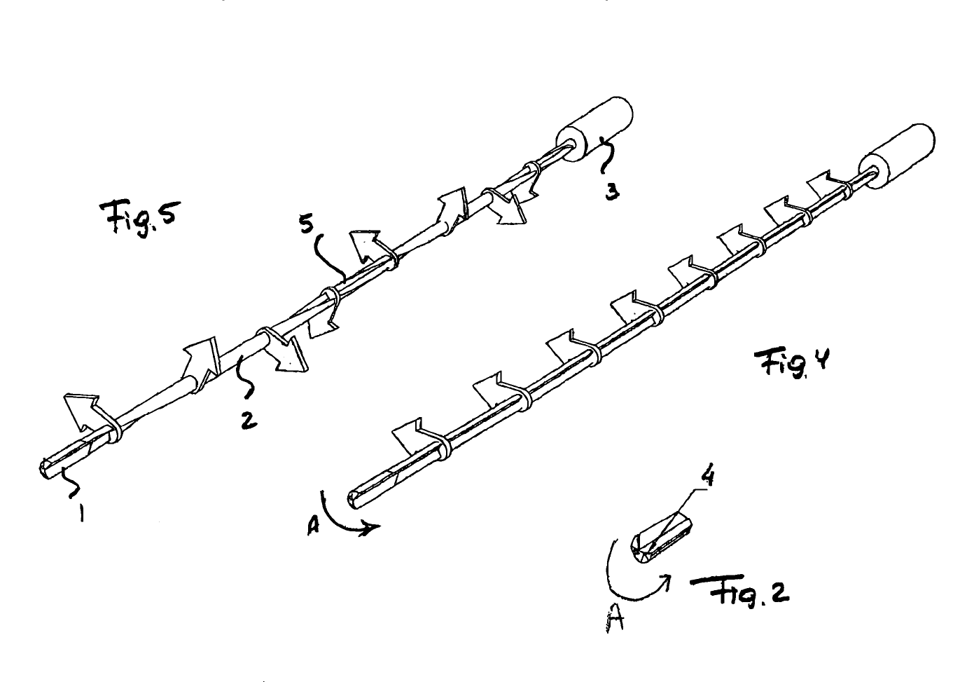

FIG. 2 shows the carbide tip 1 which has a cutting edge 4 arranged so that when the gundrill is rotated in a cutting direction which is identified with reference A, the cutting edge cuts a part to be drilled

The shank 2 is provided with one V-shaped convoluted groove or flute 5. The convoluted groove 5 of the shank is designed for a chip removal during cutting.

In accordance with the present invention the convoluted groove 5 has a direction of its convolution, which corresponds to the cutting direction of the gundrill.

The gundrill of the present invention provided with the V-fluted shank is configured to perform a counterclockwise rotation as observed from the tip end, coinciding with the rotation of the cutting edge in the hole, and thus improving the ability of the gundrill to receive the chip segments for evacuation along the V-flute or groove 5.

The convoluted groove 5 can start on the shank 2 at or near the rear end of the carbide tip 1 and can end at or near the front end of the steel driver 3.

A pitch of the groove 5 is a length of the shank required for one complete 360° rotation of the groove around the longitudinal axis of the shank. Setting the proper pitch of the convoluted groove results in the creation of the desired offsetting of the centrifugal forces, which counter-balance and nearly cancel each other so that in the drill body its axis of rotation is maintained with minimal whip.

The pitch of the convoluted groove is selected as follows:

Pitch=(rpm*diameter*(0.262)×(0.5*diameter*K),
wherein rpm is a speed of rotation of the gundrill,
diameter is a diameter of the shank of the gundrill,
k is a constant based on the configuration of the V-groove, the material and condition of the shank, and the wall thickness of the shank

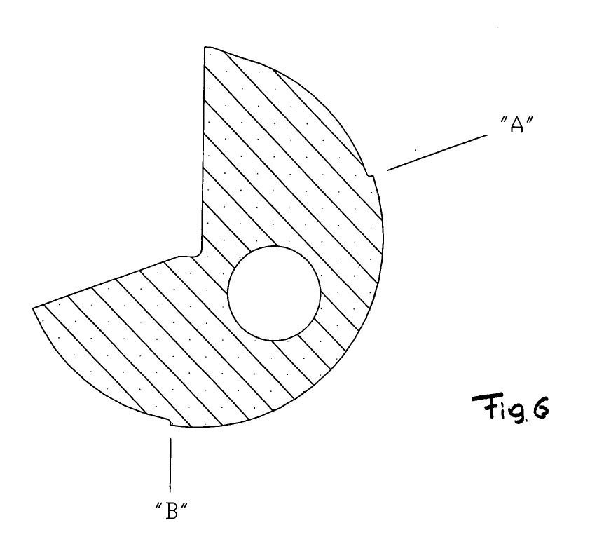

During the operation when the gundrill is rotated in the cutting direction A, the drilling is performed by the cutting edge 4 of the carbide tip 1 and burnishing is performed by the frailing wearpad(s) shown in FIG. 5 in deforming the side walls of the hole being drilled. At the same time, an efficient chip removal is performed from a cutting zone during cutting with the cutting edge 4 of the carbide tip 1 away from the carbide tip in a longitudinal direction through the convoluted groove 5 towards the shank 2.

The diameter of the shank 2 is at least 0.005″ less than the diameter of the carbide tip 1.

As can be seen from FIGS. 4 and 5, in the conventional straight groove (flute) gundrill the rotational forces acting on the gundrill are directed in the same direction resulting in the above mentioned whipping phenomena. In contrast, when the gundrill is designed in accordance with the present invention the rotational forces are directed in opposite directions, thus efficiently balancing or cancelling each other.

FIG. 6 shows a cross-section of a gundrill tip with a bearing surface A-B where the burnishing is done.

It will be understood that each of the elements described above, or two or more together, may also find a useful application in other types of constructions and methods differing from the type described above.

While the invention has been illustrated and described as embodied in a gundrill, and a method of drilling with the same, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A single flute gundrill, comprising a cutting tip having a single cutting edge arranged so that when the gundrill rotates said cutting edge performs cutting in a predetermined cutting direction; a shank having a front end to which said cutting tip is connected and a rear end; and a driver connected to said rear end of said shank, said shank being provided with a single convoluted groove with a direction of convolution coinciding with the cutting direction of the gundrill.

2. A gundrill as defined in claim 1, wherein the gundrill has a diameter within a range substantially from 0.030″ to 3.0″ and a length within a range substantially from within 3″ to 30 feet.

3. A gundrill as defined in claim 1, wherein said convoluted groove extends essentially from a rear end of said cutting tip to a front end of said driver.

4. A gundrill as defined in claim 1, wherein said convoluted groove has a pitch selected as follows:
Pitch=(rpm*diameter*(0.262)×(0.5*diameter*K),
wherein rpm is a speed of rotation of the gundrill,
diameter is a diameter of the shank of the gundrill,
k is a constant based on the configuration of the V-groove, the material and condition of the shank, and the wall thickness of the shank.

5. A method of drilling, comprising the steps of providing a single flute gundrill, comprising a cutting tip having a single cutting edge arranged so that when the gundrill rotates said cutting edge performs cutting in a predetermined cutting direction; a shank having a front end to which said cutting tip is connected and a rear end; and a driver connected to said rear end of said shank, said shank being provided with a single convoluted groove with a direction of convolution coinciding with the cutting direction of the gundrill.

6. A method of drilling as defined in claim 5, and further comprising selecting a diameter of the gundrill a diameter within a range substantially from 0.030 to 3.0 inch and a length within a range substantially from within 3 inch to 30 feet.

7. A method of drilling as defined in claim 5; and further comprising selecting said convoluted groove so that it extends essentially from a rear end of said cutting tip to a front end of said driver.

8. A method of drilling as defined in claim 5; and further comprising selecting a pitch of said convoluted groove as follows:
Pitch=(rpm*diameter*(0.262)×(0.5*diameter*K),
wherein rpm is a speed of rotation of the gundrill,
diameter is a diameter of the shank of the gundrill,
k is a constant based on the configuration of the V-groove, the material and condition of the shank and the wall thickness of the shank.
